(19) United States
(12) Patent Application Publication
(10) Pub. No.: US 2007/0169656 A1
(43) Pub. Date: Jul. 26, 2007

(54) Wallpaper printing system

(75) Inventor: Stephen Armitage, Huddersfield (GB)

Correspondence Address: BROOKS KUSHMAN P.C., 1000 TOWN CENTER, TWENTY-SECOND FLOOR, SOUTHFIELD, MI, 48075, US

(73) Assignee: MYFOTOWALL LIMITED, Huddersfield (GB)

(21) Appl. No.: 11/568,200

(22) PCT Filed: Apr. 22, 2005
(86) PCT No.: PCT/GB05/01569

§ 371 Date: Jan. 28, 2007

(30) Foreign Application Priority Data
Apr. 23, 2004 (GB) 0409032.0

(51) Int. Cl. B41F 33/00

(52) U.S. Cl. 101/483

(57) ABSTRACT

The present invention is a method and system for printing wallpaper derived from a digital image. The system comprises a host computer (130) associated with a printer (150), and a user's terminal computer (120), which communicate over a communications link (140). Using the system a plurality of printed substrates can be produced having a design (211) printed in parts thereon. The design (211) is based upon a digital image transmitted from the terminal computer (120) to the host computer (130). The digital image is divided into parts, each part being suitable for printing on one of the substrates (220, 230, 240, 250). The printer (150) prints each part on the corresponding substrate. The plurality of printed substrates (220, 230, 240, 250) can then be aligned upon a wall to recreate the design (211).

The present invention relates in general to a method and system for printing wallpaper.

Wallpaper is used for decorating the interior of a room, frequently within a home. Wallpaper usually features regularly repeating patterns, which although allowing the wallpaper to decorate a room of any size, can sometimes lack aesthetic interest.

It is possible for a consumer to have wallpaper bespoke printed to a unique design. However, even bespoke printed wallpaper features a repeating pattern, so that neighbouring widths of wallpaper can be aligned. In addition, bespoke wallpaper is expensive to have printed.

It is an aim of the present invention to provide a method of printing bespoke wallpaper in a convenient and inexpensive manner.

According to the present invention there is provided a method, system and apparatus as set forth in the appended claims. Preferred features of the invention will be apparent from the dependent claims, and the description which follows. The present invention provides a method and system for printing wallpaper derived from a digital image. The system comprises a host computer associated with a printer, and a user's terminal computer, which communicate over a communications link. Using the system a plurality of printed substrates can be produced having a design printed in parts thereon. The design is based upon a digital image transmitted from the terminal computer to the host computer. The digital image is divided into parts, each part being suitable for printing on one of the substrates. The printer prints each part on the corresponding substrate. The plurality of printed substrates can then be aligned upon a wall to recreate the design.

According to a first aspect of the present invention, there is provided a method of printing wallpaper in a printing system comprising a host computer associated with a printing means, a terminal computer, and a communication means allowing the terminal computer and the host computer to communicate, the method comprising the steps of: (a) determining target dimensions of a wallpaper boundary; (b) transmitting from the terminal computer to the host computer via the communication means a digital image to be arranged to form a wallpaper design; (c) resizing at the host computer the wallpaper design to a size substantially equal to the determined target dimensions of the wallpaper boundary; (d) dividing the resized wallpaper design to be printed in parts on a plurality of substrates, such that the printed substrates are alignable to recreate the wallpaper design; (e) transmitting from the host computer to the terminal computer via the communication means a representation of the plurality of printed substrates; (f) displaying upon a screen of the terminal computer a representation of the plurality of printed substrates for a user to view; and (g) printing upon the printing means of the host computer the plurality of substrates.

For a better understanding of the invention, and to show how embodiments of the same may be carried into effect, reference will now be made, by way of example, to the accompanying diagrammatic drawings in which:

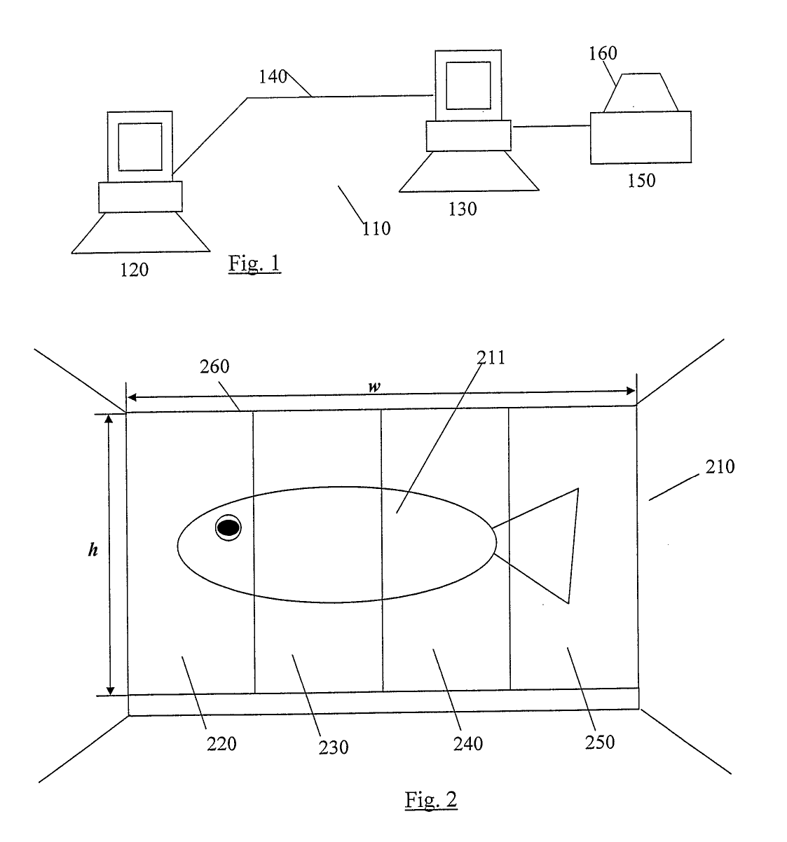

FIG. 1 is a schematic of a system adapted for use with the method detailed herein;

FIG. 2 is a diagram of a wall decorated with wallpaper produced by the present invention;

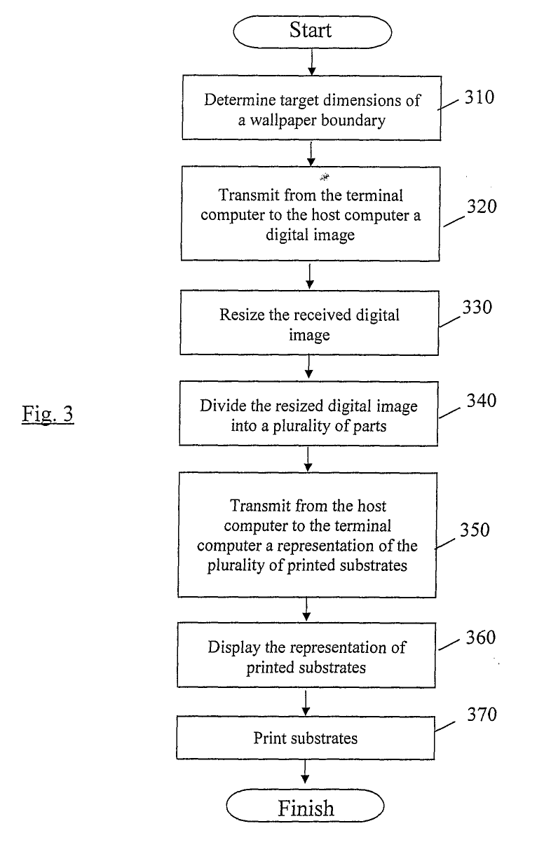

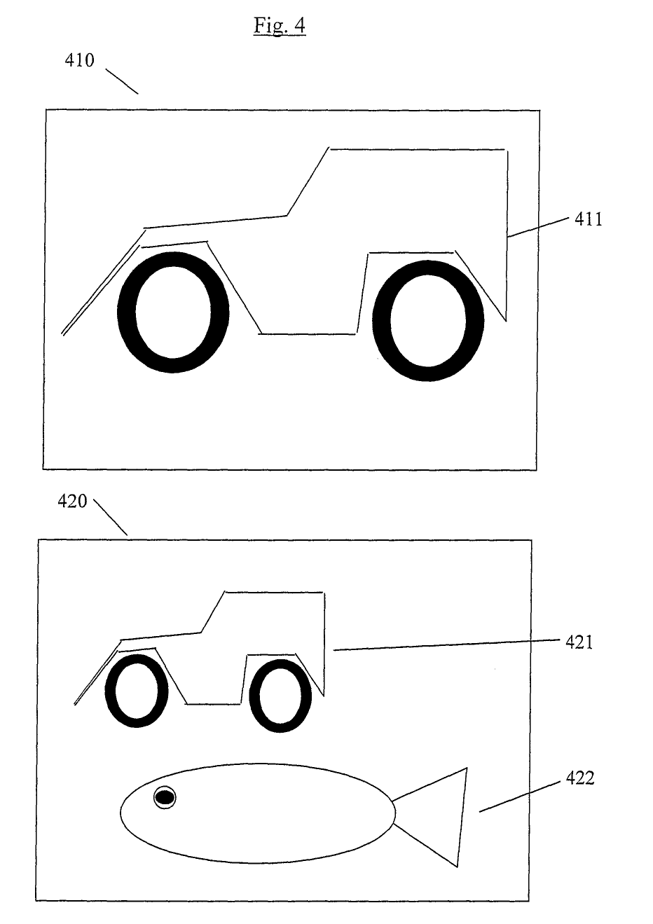

FIG. 3 is a flow chart detailing the method steps of the present invention; and

FIG. 4 is a diagram showing two digital images suitable for use with the method of the present invention.

FIG. 1 is a schematic representation of a printing system 110 adapted for use in a preferred embodiment of the present invention. The printing system 110 comprises a terminal computer 120 and a host computer 130, which communicate over a communications network 140. In the preferred embodiment, the terminal computer 120 is a user's home computer and the communication network 140 is the internet. The host computer 130 is associated with a printer 150 which prints images onto a substrate 160.

In the preferred embodiment, the printer 150 is a printer which prints images onto a substrate 160 supplied from a roll. In this way, the substrate has a predetermined width and may be cut to form a printed substrate of any length. The printer 150 may be an industrial inkjet type printer suitable for printing in colour upon the substrate 160. In the preferred embodiment of the printing system 110, the printer 150 is a Durst RHO 160 (TM) industrial strength large format flat bed digital printing press.

The use of such a large format industrial inkjet printer has numerous advantages. Firstly, accurate printing of a digital image across a plurality of substrates can be achieved, enabling later alignment of the substrates to recreate the digital image. Secondly, the substrate 160 can be printed from reel to reel so that the printed substrates 160 are stored upon a reel after printing and before being cut to a suitable length. Thirdly, such an industrial printer can achieve a relatively high-speed of printing onto the substrate 160. Lastly, an industrial inkjet printer can provide a variety of high-resolution printing modes so as to achieve a photographic appearance of the printed substrate.

In a preferred embodiment of the printing system 110, the substrate 160 is a blue-backed poster paper, which is moisture resistant and has a vinyl finish. The printer 150 prints upon the blue-backed paper using a suitable ultra-violet (UV) light curable ink. Advantageously, use of such UV curable ink produces a water-resistant printed image, which is also fade resistant. Further, the blue-backed substrate can easily be affixed to a wall using an adhesive without damage occurring, provided due care is taken and a non-solvent, pre-mixed adhesive is used.

FIG. 2 shows a wall 210 of a room, which has been wallpapered with five printed substrates 220, 230, 240, 250 produced using the printing system 110 shown in FIG. 1.

The plurality of printed substrates 220, 230, 240, 250, are aligned and adhered to the wall 210 so as to recreate a design 211 printed over the plurality of substrates 220, 230, 240, 250.

The extent of the wallpapered area 210 is defined by a height h and a width w, which together form the dimensions of a wallpaper boundary 260. The dimensions of the wall 210, or part thereof, define the dimensions of the wallpaper boundary 260.

When produced, the plurality of printed substrates 220, 230, 240, 250 may be cut to be oversize in comparison to the dimensions of the wallpaper boundary 260. Therefore, the dimensions h and w are dimensions of a target wallpaper boundary 260. For example, when the substrates 220, 230, 240, 250 are printed, an additional end area extending beyond the wallpaper boundary 260 at the upper and lower ends of each substrate may be provided. The excess edge area of each substrate is removed during the process of affixing the plurality of substrates 220, 230, 240, 250 to the wall 210, thereby producing a finished wallpapered area having dimensions of the target wallpaper boundary 260.

A preferred method of producing the plurality of printed substrates 220, 230, 240, 250 using the printing system 110 of FIG. 1 will now be described with reference to the flow chart shown in FIG. 3.

A first step 310 comprises determining target dimensions of the wallpaper boundary 260.

Step 320 comprises transmitting a digital image from the terminal computer 120 to the host computer 130 over the communications network 140. As will be appreciated by a person skilled in the art, the digital image may be, for example, a Joint Photographers Experts Group (JPEG) image, a Bitmap (BMP) image or a digital image in any other digital image file format. The design 211 printed in parts upon the plurality of printed substrates 220, 230, 240, 250 is formed by the digital image sent to the host computer 130.

In step 330 the digital image is resized. In the preferred embodiment of the present invention, the digital image is resized to have dimensions which are equal to or greater than the target dimensions of the wallpaper boundary 260, with the boundary being the crop definition of the digital image.

Step 340 comprises dividing the resized digital image into a plurality of parts, which will each be printed upon one of the plurality of substrates 220, 230, 240, 250.

A substrate of any width may be used in step 340. In the preferred embodiment of the present invention, a plurality of 500 mm wide substrates are used and the resized at least one digital image suitably divided. Suitably, use of a 500 mm wide substrate allows each printed substrate to fit onto a wallpaper pasting table. Additionally, a 1600 mm wide substrate roll can be used to produce three 500 mm wide printed substrates whilst allowing a 100 mm crop space. Additionally an identifying barcode may be printed in the crop space.

In step 350 a representation of the plurality of printed substrates 220, 230, 240, 250 having the design 211 printed thereon, is sent to the terminal computer 120.

In step 360 the representation is displayed to a user upon a display of the terminal computer 120. In a preferred embodiment of the present invention, the host computer 130 is spatially separated from the terminal computer. Therefore, displaying a representation of the plurality of printed substrates 220, 230, 240, 250 to the user allows the user to decide if the wallpaper is as desired.

Step 370 comprises printing the plurality of substrates 220, 230, 240, 250 upon the printer 150 associated with the host computer 130. Once printed, the plurality of substrates 220, 230, 240, 250 can then be attached with adhesive and aligned upon a wall 210 to recreate the design 211 desired by the user.

Advantageously, a wall 210 can be wallpapered with an un-repeating design 211, which is aesthetically interesting to a viewer. In addition, the method of printing wallpaper allows wallpaper to be created in a convenient and inexpensive manner.

In a preferred embodiment of the present invention, step 310 comprises determining the target dimensions of the wallpaper boundary 260, by the user entering the dimensions into the terminal computer 120. The target dimensions of the wallpaper boundary 260 are then transmitted to the host computer 130.

The preferred embodiment of the present invention further comprises in step 330 storing the received digital image within a storage device such as a hard disk or memory associated with the host computer 130. An enlargement factor is then determined for the received digital image. The enlargement factor corresponds to a required enlargement or scaling of the received digital image.

In one preferred embodiment of the present invention, the enlargement factor corresponds to the required enlargement of the dimensions of the digital image to equal the target dimensions of the wallpaper boundary 260. Alternatively, in another preferred embodiment of the present invention, the enlargement factor is determined by a user to resize the at least one digital image to a desired size. Once the enlargement factor has been determined then the digital image is resampled in order to resize the digital image by the enlargement factor.

Frequently, the received digital image will not be in a high enough resolution to allow resizing by the enlargement factor without an unacceptable loss in image quality occurring. For example, the loss of image quality may be a reduction in the brightness and colour of the image along with pixelisation or loss of definition in the image itself.

In the preferred embodiment of the present invention, resizing of the digital image is performed by a commercially available Adobe Photoshop®™ plug-in called pxl SmartScale™ which is available form Extensis Inc, Portland, Oreg., USA. The pxl SmartScale plug-in allows resizing of a digital image by up to 1600% of the original image size without any discernable loss of image quality.

FIG. 4 shows two examples of digital images received in step 330. The first example 410 of a received digital image file contains a single sub-image 411. The second digital image file comprises two sub-images 421 and 422. Each of the sub-images 421 and 422 are arranged to form a sub-section of the received digital image file 420. In each case, the received digital image can be resized to equal the target dimensions of the wallpaper boundary 260.

A digital image file 420 containing a plurality of sub-images 421 and 422 may be created by a user at the terminal computer 120 using suitable software. The user may use software such as Adobe Photoshop®™, Microsoft Paint or any other suitable graphics package.

In a preferred embodiment of the present invention, the digital image file is a digital photograph. Alternatively, the digital image file may comprise a plurality of digital photographs as sub-images 421 and 422. In the preferred embodiment wherein the received digital image is a digital photograph, the digital photograph is preferably in the format of a JPEG file. In the preferred embodiments of the present invention, step 350 comprises the host computer 130 sending to the terminal computer information concerning the boundary of each individual substrate 220, 230, 240, 250, which will form the printed wallpaper. In step 360, in addition to the representation of the plurality of printed substrates 220, 230, 240, 250 being displayed to the user, the location of each substrate edge in relation to the design 211 is displayed to the user.

Advantageously, displaying the edge of each printed substrate 220, 230, 240, 250 in relation to the design 211 allows the user to decide if a substrate edge lies in an aesthetically unattractive area of the wallpaper design 211. For example, if a detailed part of the design 211 falls on a substrate edge, the user can then decide to move or resize the design 211 to avoid such a part falling on a substrate edge.

In a preferred embodiment of the present invention, the method also includes a step of calculating a cost of printing the plurality of substrates 220, 230, 240, 250. The calculated printing cost is determined with reference to the target dimensions of the wallpaper boundary 260. In addition, the cost of printing the plurality of substrates 220, 230, 240, 250 is displayed to a user upon the display of the terminal computer 120.

In addition, the preferred embodiment of the present invention further comprises the step of sending a confirmation of the plurality of substrates having been printed to the user.

A preferred embodiment of the printing system 110 and method is used to produce a plurality of substrates 220, 230, 240, 250 having minimum target wallpaper boundary 260 dimensions of 1.6 by 1.6 meters.

In the preferred embodiment, the method of the present invention is implemented to run on an Apple Macintosh®™ host computer 130 such as an Apple G5™ computer connected to the Internet via a broadband connection.

As will be appreciated by those skilled in the art, the method of the present invention may be implemented using, for example, a combination of Flash®™ which is available from Macromedia Inc. San Francisco, US; and in particular Flash MX 2004 to integrate tools such as Adobe Photoshop and image printing software suitable for operating the Durst RHO 160 printer. Additionally or alternatively, a programming language such as Java may be used. Java is available from Sun Microsystems, Calif., USA. A Scripting language such as PHP 4, an open source development language, available from www.php.net along with Perl, a further open source high-level programming language available from www.perl.com may also be used to implement the method described above.

In particular, when the method is implemented on an Apple Macintosh®™ computer, a language called AppleScript®™ can be used to control Adobe Photoshop and the associated plug-in pxl SmartScale to resize the received digital image.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method for printing wallpaper in a printing system comprising a host computer associated with a printing means, a terminal computer, and a communication means allowing the terminal computer and the host computer to communicate, the method characterised by the steps of:
(a) determining target dimensions of a wallpaper boundary by transmitting target dimension information of the wallpaper boundary from the terminal computer to the host computer via the communication means;
(b) transmitting from the terminal computer to the host computer via the communication means a digital image to be arranged to form a wallpaper design;
(c) resizing at the host computer the wallpaper design to a size substantially equal to the determined target dimensions of the wallpaper boundary;
(d) dividing the resized wallpaper design to be printed in parts on a plurality of substrates, such that the printed substrates are alignable to recreate the wallpaper design at the size substantially equal to the target dimensions of the wallpaper boundary;
(e) transmitting from the host computer to the terminal computer via the communication means a representation of the plurality of printed substrates;
(f) displaying upon a screen of the terminal computer a representation of the plurality of printed substrates for the user to view; and
(g) printing upon the printing means of the host computer the plurality of substrates.

2. The method of claim 1, wherein the step (a) comprises determining the target dimensions of the wallpaper boundary by the terminal computer transmitting to the host computer said dimensions.

3. The method of claim 1, wherein the step (c) comprises the steps of:
storing the received digital image within a storage means of the host computer;
determining an enlargement factor of the digital image; and
resampling the digital image so as to resize the digital image by the determined enlargement factor.

4. The method of claim 1, wherein step (b) comprises the step of transmitting a digital image comprising a plurality of sub-images to the host computer.

5. The method of claim 1, wherein:
step (e) includes the step of transmitting to the terminal computer information concerning the location each substrate edge; and
step (f) includes the step of displaying to the user an indication of the location of each substrate edge.

6. The method of claim 1, comprising the step of calculating a printing cost of the wallpaper based upon the determined target dimensions of the wallpaper boundary.

7. The method of claim 1, wherein the digital image is a digital photograph.

8. The method of claim 1, wherein the target dimensions of the wallpaper boundary are at least 1.6 m by 1.6 m.

9. A terminal computer arranged to perform the method of claim 1.

10. A host computer arranged to perform the method of claim 1.

11. The method of claim 2, wherein the step (c) comprises the steps of:
storing the received digital image within a storage means of the host computer;
determining an enlargement factor of the digital image; and
resampling the digital image so as to resize the digital image by the determined enlargement factor.

12. The method of claim 1, wherein the step (c) comprises the steps of:
storing the received digital image within a storage means of the host computer;
determining an enlargement factor of the digital image; and
resampling the digital image so as to resize the digital image by the determined enlargement factor.

13. The method of claim 2, wherein step (b) comprises the step of transmitting a digital image comprising a plurality of sub-images to the host computer.

14. The method of claim 3, wherein step (b) comprises the step of transmitting a digital image comprising a plurality of sub-images to the host computer.

15. The method of claim 2, comprising the step of calculating a printing cost of the wallpaper based upon the determined target dimensions of the wallpaper boundary.

16. The method of claim 3, comprising the step of calculating a printing cost of the wallpaper based upon the determined target dimensions of the wallpaper boundary.

17. The method of claim 4, comprising the step of calculating a printing cost of the wallpaper based upon the determined target dimensions of the wallpaper boundary.
